(19) United States
(12) Patent Application Publication
(10) Pub. No.: US 2019/0018147 A1
(43) Pub. Date: Jan. 17, 2019

(54) SATELLITE NAVIGATION DEVICE AND METHOD FOR CONTROLLING SAME

(71) Applicant: INSTITUT SUPERIEUR DE L'AERONAUTIQUE ET DE L'ESPACE, Toulouse Cédex 4 (FR)

(72) Inventor: Vincent Calmettes, Toulouse (FR)

(73) Assignee: INSTITUT SUPERIEUR DE L'AERONAUTIQUE ET DE L'ESPACE, Toulouse (FR)

(21) Appl. No.: 16/070,493

(22) PCT Filed: Jan. 11, 2017
(86) PCT No.: PCT/EP2017/050502

§ 371 Date: Jul. 16, 2018

(30) Foreign Application Priority Data
Jan. 18, 2016 (FR) 16 50388

(51) Int. Cl. G01S 19/28; G01S 19/22

(52) U.S. Cl. CPC G01S 19/28; G01S 19/22

(57) ABSTRACT

Satellite navigation device having an architecture which uses, in parallel, an estimator based on scalar tracking and an estimator using vector tracking. As such, it is possible to compare the results given by the two estimators. In the case of a divergence between the two estimators, a study of the divergences makes it possible to determine contamination of the navigator or certain scalar channels and to modify the parameters of the navigator so as to keep a reliable measurement of the position.

The present invention relates to the field of navigation based on the use of signals from a satellite positioning system or GNSS (Global Navigation Satellite System). These signals make it possible to measure propagation delays and Doppler frequencies with respect to satellites with known positions and speeds. The quality of the delay measurements impacts the precision in terms of position, while the quality of the Doppler frequencies impacts the precision in terms of speed.

Among the difficulties that must be resolved in satellite navigation receivers, one can mention the tracking with integrity of signals in difficult environments. The problems that arise with this type of environment are mainly, the attenuation of the direct signal called LOS (Line Of Sight), the masking of this signal, or the presence of multipaths which here shall be called NLOS (Non Line Of Sight).

The basic principle of a navigation receiver consists in measuring, for each satellite from which it receives a signal, a delay which corresponds to the time that the signal takes to reach it from the satellite and a Doppler frequency which measures a frequency offset due to the relative speed of the receiver and of the satellite. From these measurements taken on several satellites and from the knowledge of the position and of the speed of each satellite, the position of the receiver can be deduced as well as its speed in relation to a land reference.

FIG. 1 shows the transmission of a signal between a satellite 1.1 and a navigation receiver 1.2. The signal emitted by the satellite 1.1 can be received by a direct path 1.4, this is the signal LOS. But this signal can also reach the navigation receiver after having been reflected, one or several times, by obstacles 1.3. These obstacles can be comprised of buildings in the urban environment, for example. The signal then follows a path 1.5 NLOS, i.e. indirect. It is thus frequent that the navigator receives multiple copies of the same emitted signal, with each copy travelling a path of its own. This phenomenon is known under the name of multipath.

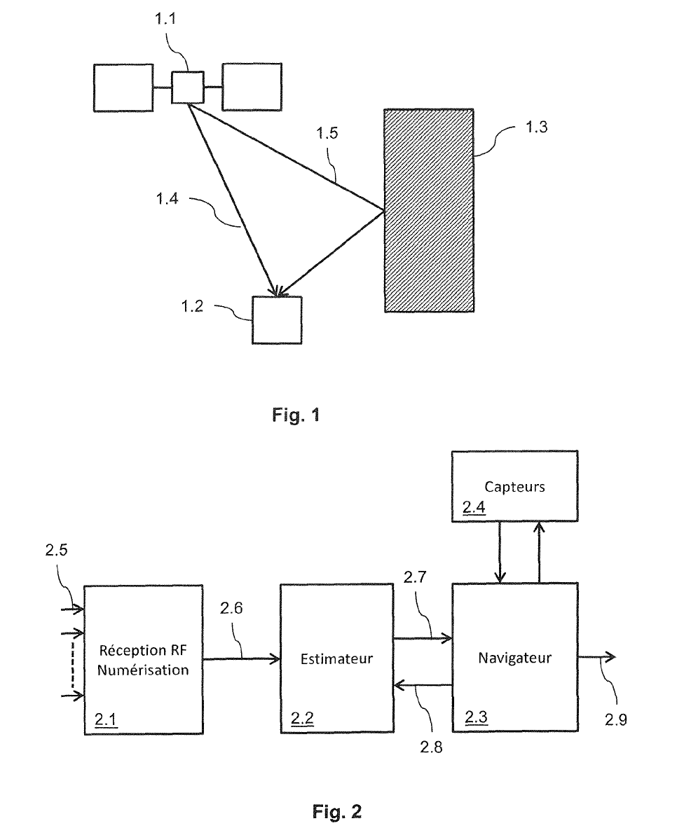

FIG. 2 shows the general architecture of a satellite navigation receiver.

The signals 2.5 emitted by the satellites are received by a radio receiver module 2.1 of radio frequency RF and digitised. The digitised satellite signals 2.6 are then transmitted to an estimator 2.2. The estimator is charged with providing an estimate 2.7, for each satellite, associated measurements of delay and Doppler frequency as well as effective values of noise on these estimates. These estimates are transmitted to a navigator 2.3. The navigator 2.3 is charged with calculating information on the position and speed of the receiver from estimates received from the estimator. It also uses a dynamic model of the displacement of the receiver that it uses to produce its own estimate of the measurements of delay and Doppler frequency of each satellite. Knowing the position of the navigator and its speed at an instant t, the model makes it possible to predict the position and the speed of the navigator at an instant t+δt, and therefore the information on the delay and the Doppler frequency for each satellite. These estimates 2.8 produced by the navigator make it possible to judge the pertinence of the measurements made by the estimator on the signal received and eventually to correct them. Optionally, the navigator can also receive information from various sensors 2.4 such as an inertial unit that supplies instantaneous measurements of acceleration projected into the navigation mark thanks to the use of gyroscopes that give indications of angular speed. This information can then be integrated into the dynamic model of the navigator and improve the precision of the estimates. It is the navigator which, using its own estimates and estimates received from the estimator, consolidates the information of the position and speed 2.9 supplied as a result of the positioning.

The estimate of the delay and Doppler frequency of the signal received is based on what is called tracking loops within the estimator. The operating principle of the tracking loop is as follows. The signal received from the satellite has a known form. It is received by the receiver with a phase and frequency offset linked to the travel time and relative speed. In order to obtain an estimate of these offsets making it possible to estimate the delay and the Doppler frequency sought, a replica of this signal is created locally. This replica signal is generated by numerically controlled oscillators (NCOs) and result from the mixing of a carrier signal and of a code signal. These NCOs are configured according to a value of the Doppler frequency and a phase error regarding the carrier signal, according to a Doppler frequency and a delay error regarding the code signal, and generate a signal, replica of the signal emitted by the satellite, the delay and the frequency of which correspond to the delay and Doppler frequency of the signal received. The replica signal is then compared to the signal received using a correlator. The result of the correlation will be higher when the replica signal is close to the signal received and therefore the values of the delay and Doppler frequency used to configure the NCOs will be close to the delay and Doppler frequency affecting the signal received from the satellite. A loop is then carried out in order to progressively refine the parameters of the NCOs until a strong correlation is obtained. When the latter is obtained, the values of the delay and Doppler frequency that correspond to these parameters of the NCO supply the estimate by the tracking loop of the values of the delay and Doppler frequency affecting the satellite signal received. In practice, several correlators are required to construct discriminators that measure the frequency, phase and delay errors.

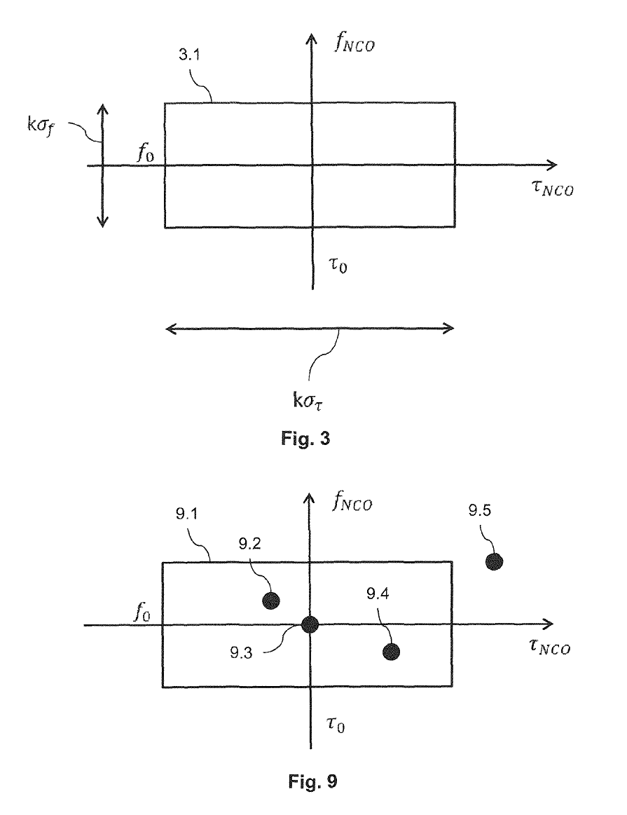

One of the important parameters of the convergence via correlation used is the delay-frequency discrimination window. This discrimination window is defined here as the range of measurement wherein the estimators operate by using the outputs of the discriminators elaborated through correlation of the signal received with local replicas. In practice, the replica signal is defined from a prior estimate of the value of the delay and Doppler frequency. This prior estimate is affected with a noise, the effective value of which is known whether for the delay or for the Doppler frequency. The size of the discrimination window must be dimensioned taking account of the knowledge of the effective noise values affecting the initial estimate. It represents the range expressed in two dimensions, the delay and the Doppler frequency, wherein a correlation with the signal received will be sought. The delay-frequency discrimination window is shown in FIG. 3.

This figure shows the discrimination window 3.1 in a two-dimensional space defined by the values τ_{NCO} for delay and the values f_{NCO} for Doppler frequency of the replica signal. The discrimination window is centred on the values of the estimate defined by the delay τ₀ and the Doppler frequency f₀. The dimensions of the discrimination window are defined by a scalar value k multiplied by the effective value of the noise affecting the delay, σ_{τ}, and the Doppler frequency, σ_{f}. The measurement will consist in seeking within the discrimination window the values for the delay and for the Doppler frequency which, applied to the replica signal, provide the best correlation with the signal received.

It is easily understood that this convergence mechanism is all the more so effective, fast and precise that the initial values for the delay and for the Doppler frequency used to generate the replica signal are close to the values for the delay and for the Doppler frequency affecting the signal received. In practice, in an established regime, the values for the delay and for the Doppler frequency at an instant t are comprised of estimates obtained at the instant t−δt. However, at the starting of the receiver, in the absence of prior estimates, the phenomenon of convergence can take a certain amount of time, time known under the name of acquisition time of the satellite. Once the satellite is “hooked”, i.e. once estimates are close to the actual values of the delay and Doppler frequency affecting the signal received have been obtained, the convergence is rapid, the loop tracks the satellite.

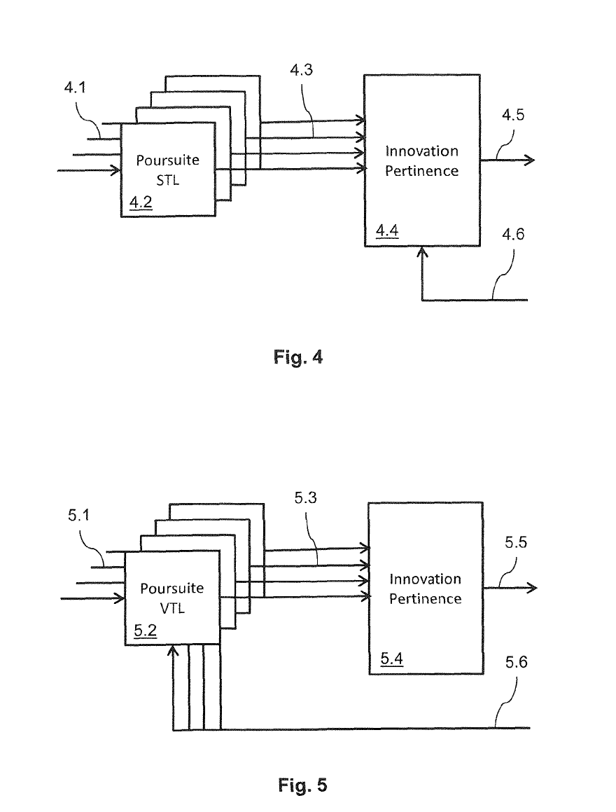

Conventional receivers use a tracking referred to as scalar of the signals emitted by the satellites. The tracking mode is called STL (Scalar Tracking Loop). It is based on a direct architecture that uses GNSS signal tracking loops upstream of the navigator. The tracking loops, the number of which depends on the number of satellites available, operate independently of one another, but also independently of the navigator. FIG. 4 shows an estimator based on scalar tracking loops.

The digitised signals 4.1 received from the satellite are processed by scalar tracking loops 4.2. The scalar tracking loops produce estimates 4.3 of the values of the delay \tilde{τ}^{m} and frequency \tilde{f}^{m} as well as a measurement of the effective values of the noise affecting these estimates, respectively σ_{τ}^{s,m} and σ_{f}^{s,m}, with the exponent S expressing that the loop is scalar and m being an index of the satellite concerned.

On its side, the navigator makes estimates based on its dynamic model taking account of all of the satellite signals received as well as the information from any complementary sensors. These estimates 4.6 are noted respectively as \tilde{τ}^{m} for the delay, \tilde{f}^{m} for the Doppler frequency, and σ_{τ}^{V,m} and σ_{f}^{V,m} for the associated effective noise values.

The estimates 4.3 coming from the tracking loops and the estimates 4.6 coming from the navigator are sent to a module for calculating the innovation and the pertinence 4.4. The terms innovation (or residue) means the difference between the measurement taken and the measurement estimated by the navigator. The amplitude of the innovation (of the residue) of a measurement makes it possible to establish a criterion of pertinence of this measurement. When this difference is not compatible with the effective noise values, it is deduced that the measurement is erroneous, it is then declared as not pertinent and will not be transmitted to the navigator. It is also said that the channel associated with this satellite is contaminated. The pertinent measurements 4.5 are then transmitted to the navigator for updating the position and the speed of the receiver. This approach assumes that the navigator itself is not contaminated.

The main characteristic of estimators based on scalar tracking loops is that the estimate made on a channel, i.e. on a given satellite signal, is entirely independent of the estimates made on the other channels. The tracking loop propagates estimates that depend only on the preceding local estimate of the same channel, and measurements produced by this channel. In other terms, the estimate used to program the NCOs for the generating of the replica signal is directly the preceding result of the tracking loop STL and of the measurements obtained locally. However, because of this, the estimate is sensitive to the noise and disturbance affecting this channel. In particular in the case where the satellite signal is subject to multipaths, the latter can generate contaminated measurements that can substantially affect the estimate. Likewise, the scalar approach shows its limits when the signal is of low power. The noise level increases degrading by as much the precision of the measurement. The problem of the temporary masking of a satellite also arises. In this case, the reception of the signal is interrupted leading to a dropout of the scalar tracking loop. When the signal reappears, it is then necessary to again acquire the satellite which can lead to a more or less long time without a valid estimate.

In order to overcome these disadvantages and mainly the weakness of scalar tracking loops, when the signal is of low power, estimators based on vector loops have been proposed. The architecture of an estimator based on vector loops has been proposed. It is shown in FIG. 5.

The main difference with FIG. 4 is that the tracking loops 5.2, here vector loops, which take as input the signals 5.1 received from the satellites, also take as input the estimates 5.6 supplied by the navigator. The estimates 5.3 supplied by the tracking loops are then transmitted to the module 5.4 which calculates the innovations 5.5 which are transmitted to the navigator. The module 5.4 also produces information on the quality of these innovations used by the navigator. This configuration of the receiver uses information elaborated by the navigator from all of the measurements that it has, therefore the measurements of all of the channels of the receiver GNSS and, where applicable, the measurements coming from complementary sensors, in order to deliver to each canal information which is used, within the tracking loops of the signals, for the controlling of numerically controlled oscillators (NCOs). This cooperative approach makes the channels dependent on one another. An elementary analysis reveals a major disadvantage of this architecture. By rendering the tracking channels dependent on one another, and eventually dependent on other measurements, this architecture undergoes a degradation when the navigator does not know how to discard a contaminated measurement. The term contaminated measurement means a measurement, the consistency of which has been compromised because the signal was too weak or multipaths have disturbed the measurement. In a difficult environment such as an urban environment, the risk of pollution between channels must be considered, which can result in a divergence of the navigator making it impossible to use the measurements taken by the loops VTL. For this reason, this architecture is not used today to address the problem of multipaths in urban environment. It however satisfies the constraint of tracking low power signals.

The quality of the scalar tracking carried out on a single canal, i.e. the estimation noise of this channel, is according to the local measurements that it has and is subject to the noise affecting the reception of this channel. Therefore, the discrimination window used for the scalar tracking, the size of which depends directly on the noise on the estimates, therefore the noise affecting the measurement, must be relatively large. Therefore, it is sensitive to the presence of multipaths of which the delay and Doppler frequency per se make the multipath being present in the discrimination window.

The vector tracking, due to the fact that the estimate used is that of the navigator consolidated on all of the available channels, is affected with a more reduced noise. The discrimination window is therefore more reduced and therefore less sensitive to the presence of multipaths of which a larger number of which will be outside of this discrimination window. However, due to the smaller discrimination window, the vector tracking is very sensitive to the accuracy of the estimate of the navigator. In particular, if contaminated measurements were to tarnish the estimate of the navigator, with the latter producing an estimate affected with an error greater than the discrimination window, due to the propagation of these contaminated measurements between the channels, the tracking cannot converge towards a correct measurement. It is then said that the navigator is contaminated.

The present invention has for purpose to resolve the aforementioned disadvantages by proposing navigation receiver architecture that uses in parallel an estimator based on a scalar tracking and an estimator using a vector tracking. As such, it is possible to compare the results given by the two estimators. In case of divergence between the two estimators, a study of the residues that represent the difference between the local estimates and the estimates of the navigator makes it possible to determine a contamination of certain scalar channels, or of the navigator, and to modify the parameters of the navigator in order to keep a reliable measurement of the position.

The invention relates to a satellite positioning device, comprising a module for radio receiving and for digitising signals received from the satellites, each signal received from a satellite defining a satellite channel; an estimator for determining a measurement of the delay and frequency of each satellite channel; a navigator for determining from all of the measurements of the estimator an estimate of the position and speed of the device. The estimator comprises for each satellite channel: a scalar tracking loop of the measurement of the delay; a vector tracking loop of the measurement of the delay in parallel with the scalar loop; and means of comparison of the delay estimates of the scalar tracking loop and of the vector tracking loop produced by the estimators of said scalar and vector loops operating in parallel, for determining the integrity of the measurement of the delay and therefore of the satellite channel concerned.

According to a particular embodiment, said scalar and vector loops comprising numerically controlled oscillators carriers of the estimate of the delay of said loops, the means for comparing estimates of the delay of the scalar tracking loop and of the vector tracking loop comprise means for comparing the state of said numerically controlled oscillators.

According to a particular embodiment, said scalar and vector loops comprising discriminators of the delay, the means for comparing estimates of the delay of the scalar tracking loop and of the vector tracking loop comprising means for comparing the outputs of said discriminators.

According to a particular embodiment, the estimator further comprises means for determining the integrity of the navigator from the determination of the integrity of the measurements of the delay of all of the satellite channels.

According to a particular embodiment, the navigator comprises means for discarding the measurement from satellite channels determined as contaminated by the estimator.

According to a particular embodiment, the vector tracking loop comprises a first discriminator, referred to as narrow, using correlators the offset of which is based on the power of the noise affecting the overall estimate of the navigator; the vector tracking loop further comprises a second discriminator, referred to as wide, using correlators of which the offset is based on the power of the noise affecting the local scalar estimate; and means of control for determining which discriminator is used to establish the measurement of the delay of the vector loop.

The invention also relates to a method for controlling a satellite positioning device, comprising a module for radio receiving and for digitising signals received from the satellites, each signal received from a satellite defining a satellite channel; an estimator for determining a measurement of the delay and frequency of each satellite channel and a navigator for determining from all of the measurements of the estimator an estimate of the position and speed of the device; the estimator comprising for each satellite channel: a scalar tracking loop of the measurement of the delay; a vector tracking loop of the measurement of the delay in parallel with the scalar loop. The method further comprises a step of comparing measurements of the delay of the scalar tracking loop and of the vector tracking loop produced by the estimators of said scalar and vector loops for determining the integrity of the measurement of the delay and therefore of the satellite channel concerned.

According to a particular embodiment, the vector tracking loop comprising a first discriminator, referred to as wide, using correlators of which the offset is based on the power of the noise affecting the local scalar estimate; the vector tracking loop further comprising a second discriminator, referred to as narrow, using correlators of which the offset is based on the power of the noise affecting the overall estimate of the navigator; the method further comprises: a step for determining which discriminator is used to establish the measurement of the delay of the vector loop.

According to a particular embodiment, the method comprises: a step of acquiring satellites; a step of switching to a scalar mode when a sufficient number of satellites is acquired, the measurement of the estimator then being produced by the scalar loop; a step of switching to a degraded vector mode when the navigator is able to converge towards an estimate of the position and speed, the measurement of the estimator then being produced by the vector loop based on the wide discriminator, the scalar loop being tracked in parallel; a first step of switching to a transition mode, the measurement of the estimator then being produced by the vector loop based on the wide discriminator and on the narrow discriminator, the scalar loop being tracked in parallel; a step of switching to a healthy vector mode when the state of the navigator is determined to be healthy by comparison of the measurements of the scalar loop and of the vector loop, the measurement of the estimator then being produced by the vector loop based on the narrow discriminator, the scalar loop being tracked in parallel; and a second step of switching to the transition mode when the state of the navigator is determined to be contaminated by comparison of the measurements of the scalar loop and of the vector loop.

The invention also relates to a computer program comprising instructions suitable for the implementation of each one of the steps of the method according to the invention when said program is executed on a computer.

The invention also relates to a means for storing information, removable or not, partially or entirely able to be read by a computer or a microprocessor comprising code instructions of a computer program for the execution of each one of the steps of the method according to the invention.

In a particular embodiment, steps of the aforementioned method are determined by instructions of computer programs.

Consequently, the invention also relates to a computer program on an information support, with this program being able to be implemented by a microprocessor, with this program comprising instructions being suitable for implementing the steps of the method such as mentioned hereinabove.

This program can use any programming language, and be in the form of source code, object code, or an intermediate code between a source code and an object code, such as in a partially compiled form, or in any other desirable form.

The invention also relates to an information support that can be read by a microprocessor, and which comprises instructions of a computer program such as mentioned hereinabove.

The information support can be any entity or device capable of storing the program. For example, the support can include a means of storage, such as a ROM, for example a microcircuit ROM, or magnetic means of recording, for example a hard drive, or a flash memory.

On the other hand, the information support can be a support that can be transmitted such as an electrical or optical signal, which can be conveyed via an electrical or optical cable, by radio or by other means. The program according to the invention can be in particular downloaded on a storage platform of a network of the Internet type.

Alternatively, the information support can be an integrated circuit wherein the program is incorporated, with the circuit being suitable to execute or to be used in the execution of the method in question.

The information support and the computer program mentioned hereinabove have characteristics and advantages that are similar to the method that they implement.

Other particularities and advantages of the invention shall further appear in the description hereinafter in relation with the accompanying drawings, given as non-limiting examples:

FIG. 1 shows the transmission of a signal between a satellite and a navigation receiver;

FIG. 2 shows the general architecture of a satellite navigation receiver;

FIG. 3 shows the concept of a delay-frequency discrimination window;

FIG. 4 shows the operation of a tracking loop STL;

FIG. 5 shows the operation of a tracking loop VTL;

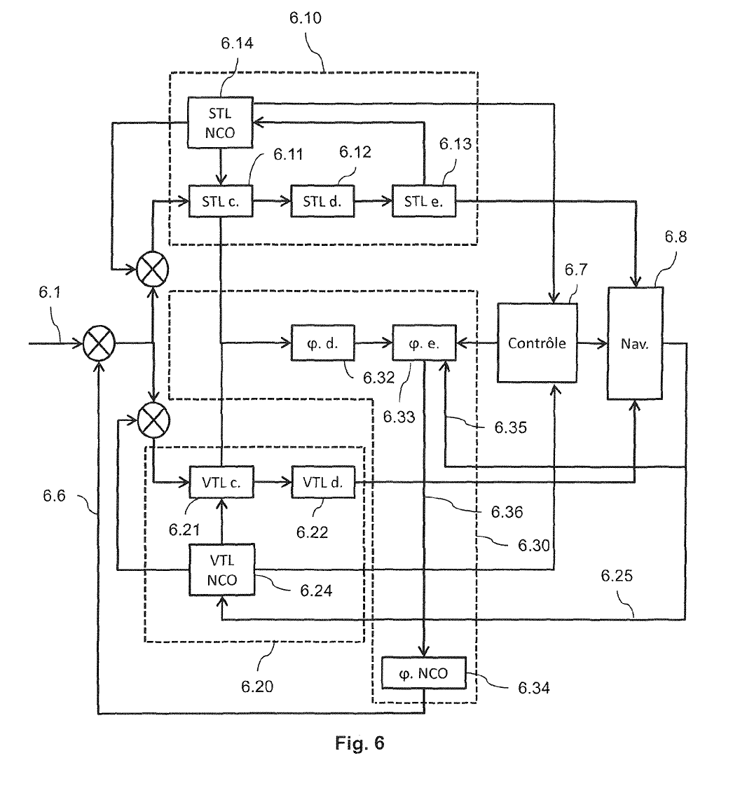

FIG. 6 shows the architecture of a receiver according to an embodiment of the invention;

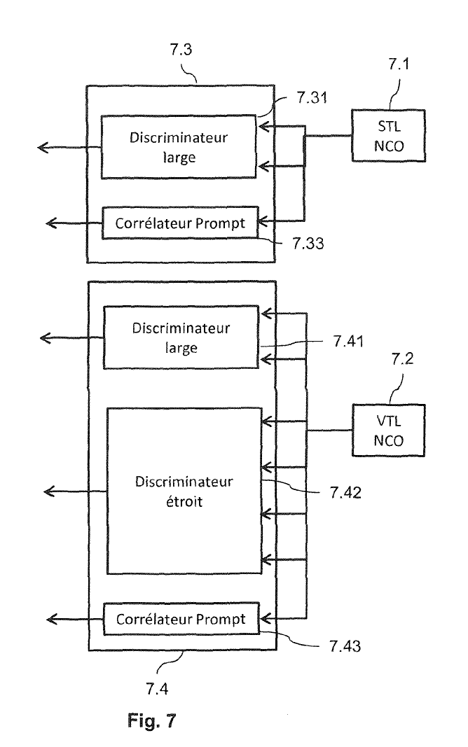

FIG. 7 shows the architecture of the devices for measuring the delay according to an embodiment of the invention;

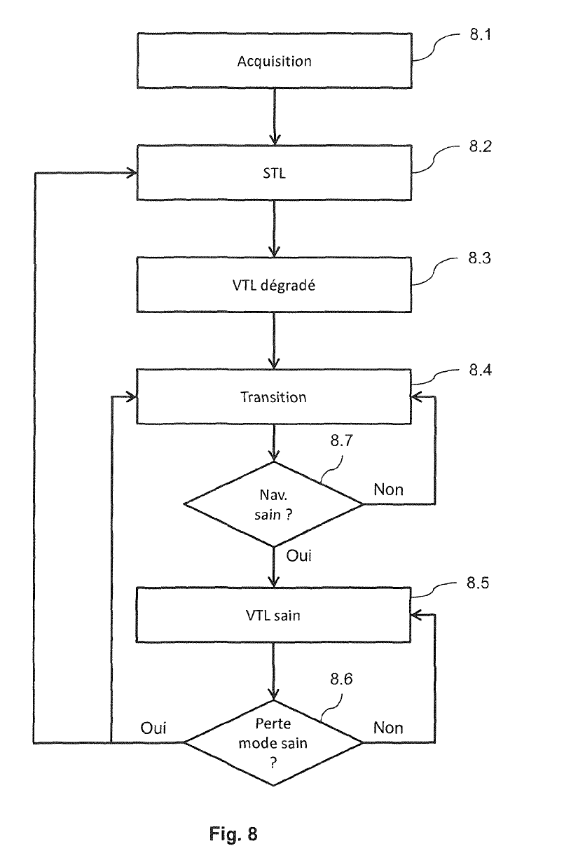

FIG. 8 shows the various types of control according to an embodiment of the invention;

FIG. 9 shows the impact of multipaths on the measurement of the delay in liaison with the delay-frequency discrimination window;

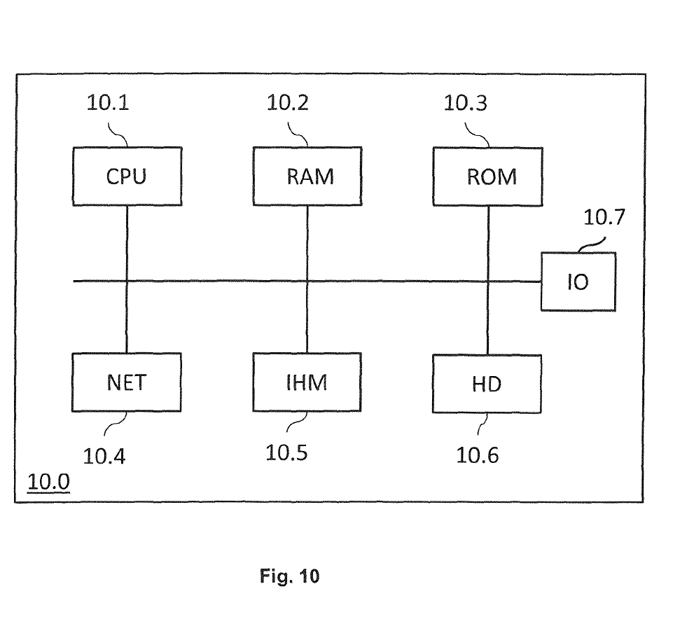

FIG. 10 is a schematic block diagram of an information processing device for the implementation of one or several embodiments of the invention.

The basic idea of the invention consists in jointly using in parallel a tracking loop STL and a tracking loop VTL for estimating the delay of each satellite measurement. The tracking mode of the phase is indifferent to the invention, it can be of the STL, or VTL type according to the embodiments. However, the layout of this loop can benefit of the assistance from the navigator, in particular when the latter benefits of the assistance in speed (Inertial unit, differential measurements produced by a barometer, a mechanical or optical odometer, etc.). The quality of this assistance impacts the dimension of the discrimination window in the vertical dimension (frequency).

This putting into parallel of a loop STL and of a loop VTL makes it possible to confront the innovations obtained for each one of them by comparing the state of the NCOs of the two loops. This comparison makes it possible at any time to determine which channels are healthy and which are contaminated. It is also possible to determine if the navigator is healthy or contaminated, and to evaluate the level of contamination of the navigator. Therefore, it becomes possible to implement a control that takes advantage of this information to discard, when this is possible, the contaminated channels in order to retain a healthy navigator. It is also possible to implement a control that makes it possible to return the navigator to a healthy state when it becomes contaminated.

Advantageously, the loops STL and VTL used for the tracking of the delay are based on similar architectures, in such a way as to increase the pertinence of the comparison of the signals at the output of the discriminators. In addition, this approach makes it possible to benefit from the filtering of the measurements carried out between two updates of the navigator by the tracking loops in order to construct at the input of the navigator innovations used for controlling the integrity of the measurements and of the navigator affected with a very low level of noise.

FIG. 6 shows the architecture of a receiver according to an embodiment of the invention. The signal 6.1 received from the satellite is subjected in this example to three separate estimators. This figure shows the processing of a particular channel. A channel being the processing chain of the signals of a satellite. There are therefore as many processing chains as there are satellite signals captured by the receiver. In the figure, only the control unit 6.7 and the navigator 6.8 are common to all of the channels.

A first estimator 6.30 is dedicated to the tracking of the carrier of the signal, this here entails tracking the frequency via the phase. The signal received is mixed with the carrier signal 6.6 produced by the NCO unit 6.34 and subjected to a correlator, typically the prompt correlator of the module STL 6.11 or VTL 6.21. The result of the correlation is then submitted to a unit of discriminators 6.32 allowing for the measurement of phase and frequency errors. The output of the discriminators 6.32 is then treated by an estimation unit 6.33 for the estimation of the measured frequency of the input signal. It is this local estimate 6.36 that is used to control the replica carrier signal via the NCO unit 6.34. This is therefore here the conventional structure of a loop STL for the tracking of the carrier of the signal.

In an embodiment, the estimate of the carrier frequency 6.35 carried out by the navigator 6.8 is also used by the local estimator 6.33. There is in this case a loop STL referred to as assisted. The estimate of the navigator is used to refine the local estimate. The loop indeed remains a scalar loop due to the fact that the programming of the NCOs 6.34 is correctly carried out from the local estimate and not from the estimate of the navigator.

In the context of the invention, the phase-frequency tracking can be done indifferently by a tracking loop STL, an assisted tracking loop STL, use the outputs of the prompt correlator associated with the loop STL, or the one associated with the loop VTL. However, according to a particular embodiment of the invention, the control module 6.7, details on the operation of which shall be provided further on, can be used to switch between a pure mode STL and an assisted mode STL, and select the most suitable prompt correlator, according to the information on the integrity of the navigator.

A second estimator 6.10 is implemented for estimating the delay. This estimator is a scalar tracking loop, therefore of the STL type. The conventional elements of such a tracking loop are found. A correlation unit 6.11 in order to establish the correlation between the signal received and the replica signal generated by the NCO unit 6.14. The result of the correlation is submitted to a unit of discriminators 6.12 in order to estimate the differences in delay, with the delay discriminator measuring the residue on the delay used for controlling a scalar loop. Then, the estimation unit 6.13 is charged with producing the frequency that controls the NCO unit 6.14. This unit carries the information of the resulting delay. The loop is scalar, it is therefore this local frequency estimate produced by the estimation unit 6.13 which is used to program the NCO unit 6.14. This NCO as such carries the estimated state which represents the estimated measurement of delay.

One of the innovating aspects of the architecture proposed is to place this scalar estimator 6.10 in parallel with another vector estimator 6.20, used for its precision allowing for a reduction in the range of the discrimination window. This estimator VTL comprises a replica signal generator 6.24 based on NCOs, complementary with the scalar generator NCO 6.14, a correlation unit 6.21 and a unit of discriminators 6.22, with the set of delay discriminators measuring the residues on the delays used for the controlling of the vector loop. As the tracking loop is vector, the local estimator disappears to the benefit of the navigator 6.8. It is indeed the latter that is charged with producing, from the delay measurements obtained by a reading of the state of the NCOs 6.24 and of the output of the discriminators 6.22 of all of the channels, the estimate of the control frequency of the NCO that produces the delay of the channel. Differently to the local estimator 6.13 of the scalar loop, the estimate made by the navigator uses all of the measurements available to produce its estimate. These measurements come from all of the GNSS channels available plus possible other systems such as inertial units, baro-altimeters, odometers or others. This estimate 6.25 of the frequency of the NCO which controls the delay of the channel concerned, established from all of the channels available by the navigator, is used for the programming of the replica signal generator 6.24.

Another innovating aspect of the architecture proposed is the control module 6.7. This module uses the measurements of the signal-to-noise ratio of each channel and performs a comparison of the innovations (residues) elaborated, for each channel, by comparing the state of the NCO 6.14 of the scalar loop to the state of the NCO 6.24 of the vector loop. This comparison is pertinent and makes it possible to improve the power of the tests carried out to detect the healthy channels and the contaminated channels. It is also possible to also verify the integrity of the navigator from a global analysis of these same residues. This control module is then able to control the scalar and vector loops according to these elements, to exclude the contaminated channels and to return a contaminated navigator to a healthy mode as we shall see further-on.

Alternatively, according to another embodiment not shown in FIG. 6, the comparison of the estimates of the delay of the scalar and vector loops, can be carried out by comparing the outputs of the discriminators 6.12 and 6.22 of said loops instead of the comparison of the states of the NCOs.

The correlation of the replica signal with the signal received is in practice carried out by a plurality of correlators. This correlation uses at least two correlators. A first correlator establishes the correlation between the signal received and a version in advance of the replica signal generated. This correlator is then qualified as an early correlator. A second correlator establishes the correlation between the signal received and a late version of the replica signal generated. This correlator is then qualified as a late correlator. In addition, an additional correlator establishes the correlation between the signal received and a version without offset of the replica signal generated. This correlator is qualified as a prompt correlator (without delay).

In practice, the measurement of the delay is carried out on a discrimination window that depends, in the range of the delay, on the offset values used for the early and late correlators. Using substantial offset values between the early signals and the late signals leads to a wide delay-frequency discrimination window on the axis of the delay. On the contrary, small offset values between the early signals and the late signals allow for a narrow delay-frequency discrimination window. In order to produce narrow discrimination windows that have good performance note that, for BPSK signals such as defined for the GPS/L1 C/A system, it is necessary to use early and late correlators for several offset values. However, for BOC(m,n) signals, such as those used for the wide band GNSS signals of the new generation systems, implementing wide discriminators may require a particular processing of the BOC signals.

For the frequency dimension, the later is defined by the noise band of the estimator used by the frequency tracking loop. This noise band can be reduced by using a quality clock for the receiver and/or an assistance of the navigator, especially when the latter benefits from speed measurements (inertial unit, differential pressure measurement, mechanical or optical odometer).

In the rest of this document, we shall speak of wide delay-frequency discrimination window when its dimension in the range of the delay is based on the power of the noise of the local estimate of the delay and of the amplitude of the possible disturbances. We shall use the term narrow delay-frequency discrimination window when its dimension in the range of the delay is based on the power of the noise of the global estimate made by the navigator, with the dimension of this window fixing the performance that the receiver can achieve. In practice, the narrow discrimination window is used by the loop VTL in its nominal mode (mode 8.5 of FIG. 8). Its width can be adjusted dynamically according to the power of the noise on the delay estimated by the vector loop. The wide discrimination window is used in the transition mode (mode 8.4 of FIG. 8) and the degraded mode VTL (mode 8.3 of FIG. 8). It accepts perturbations of the loops which reduces the risk of dropout.

The sensitivity of the measurement of the delay to multipaths is directly linked to the size of this delay-frequency discrimination window. FIG. 9 shows the impact of an indirect path one the measurement taken by the correlators.

We have seen that an indirect signal, referred to as signal NLOS, is received by the receiver affected with a delay that is different from the delay affecting the direct signal, referred to as the signal LOS. This is due to the fact that the two signals have travelled paths of a different length.

An indirect signal that has a difference in delay with the direct signal greater than the width of the delay-frequency discrimination window does not disturb the measurement. It is said that the indirect signal falls outside of the discrimination window. In FIG. 9, the point 9.2 shows the direct path or LOS of which it is sought to measure the delay. The point 9.3 shows the estimate used by the loop, i.e. the replica signal affected with its delay and its frequency. This point is the central point of the delay-frequency discrimination window 9.1, in the mode VTL when the navigator is not contaminated. The point 9.5 shows an indirect path falling outside the delay-frequency discrimination window. This signal does not disturb the measurement taken by the correlators corresponding to the delay-frequency discrimination window shown.

On the contrary, an indirect signal shown by the point 9.4 falls in the discrimination window 9.1. The correlation will, in this case, compare the replica signal with the sum of the signal 9.2 resulting from the direct path and the indirect signal 9.4. The tracking loop thus converges towards an intermediate position between the points 9.2 and 9.4. The delay measured is affected with an error due to the presence of the indirect path 9.4 in the discrimination window.

It is then understood that one of the keys for reducing the impact of multipaths is the size of the delay-frequency discrimination window. For example, a more reduced window 9.6, by discarding the signal 9.4, would have made possible a healthy measurement of the delay of the signal 9.2 contrary to the delay-frequency discrimination window 9.1 which leads to a measurement contaminated by the signal 9.4. However, as we have seen, the size of the delay-frequency discrimination window is linked to the level of noise affecting the estimate for generating the replica signal. Indeed, using a discrimination window that is too small runs the risk of not containing the direct signal that is sought to be measured and in this case no measurement is possible.

FIG. 7 shows the architecture of the devices for measuring the delay according to an embodiment of the invention.

In the embodiment of FIG. 7, the loop STL 7.3 uses a conventional discriminator based on the output of an early correlator and of a late correlator making it possible to carry out a discriminator 7.31 operating over a wide discrimination window. These correlators take as input the replica signal generated by the unit of NCOs 7.1 and the signal received not shown. As we have seen, the tracking loops STL are affected with a relatively high level of noise. Moreover, they are used for the elaboration of test signals and must be able to accept disturbances. Because of this, the wide discriminator of the correlation unit STL (and VTL) is a wide discriminator defined by correlators with relatively large offset values, insuring the robustness of the loop STL and the validity of the tests in a disturbed environment, based on the power of the noise of the scalar local estimate. The associated delay-frequency discrimination window is therefore qualified as wide.

The loop VTL 7.4 comprises a narrow discriminator 7.42 defined by so-called narrow correlators with relatively small offset values. The choice of the width of the discrimination window then depends on the precision of the estimate of the navigator used by the loop VTL and therefore on the power of the noise affecting this estimate. Using auxiliary systems such as an inertial unit, choosing a high sampling frequency of the signal 2.6, using a good-quality oscillator, can lead to a very narrow delay-frequency discrimination window. The vector tracking loop based on these narrow correlators forming a narrow discriminator is consequently qualified as a narrow vector tracking loop. These correlators take as input the replica signal generated by the unit of NCOs 7.2 and the signal received not shown.

In an optional and innovating manner with respect to known vector loops, the vector loop is also provided with a wide discriminator 7.41, equivalent to the one used by the scalar loop, which can result from a reconfiguration of the narrow discriminator when the healthy mode 8.5 cannot be maintained. This discriminator is used in modes 8.3 and 8.4 for tracking VTL in degraded mode, qualified as a wide vector tracking loop. This loop is even so a vector tracking loop because it uses an input the replica signal coming from the NCO unit 7.2 generated from the estimate of the navigator contrary to the scalar loop which uses the replica signal coming from the NCO unit 7.1 generated from the local estimate.

In an environment that generates multipaths, a receiver that uses a scalar tracking will be very sensitive to the disturbances introduced by these multipaths. Indeed, as we have seen, scalar tracking loops necessarily use a wide delay-frequency discrimination window which will be able to include many indirect signals. Therefore, the tracking channels tend to become contaminated. As long as the navigator is healthy, it is possible to determine the contaminated channels through a comparison of the measurement coming from the local estimator of the scalar tracking loop and the estimate provided by the navigator. A substantial difference, i.e. greater than the uncertainty introduced by the noise, indicates a contaminated channel.

The navigator then discards the measurements produced by these channels in order to generate its estimate. This approach is not satisfactory for the following reasons. On the one hand, the scalar measurement and the estimate of the navigator are not synchronous in time. As the estimate of the navigator is made from measurements of previously estimated scalar loops, a temporal bias is introduced into the comparison at the same instant of the scalar measurement and of the estimate of the navigator. This bias degrades the precision of the comparison if the models of the state of the estimators are not adapted to the dynamics of the vehicle. Finally, scalar loops are more sensitive to multipaths, as the dimension of the discrimination window is limited by the power of the estimation noise of the loop STL. A moment therefore occurs when the exclusion of a contaminated measurement fails, or when there is no longer a sufficient number of healthy channels. The integrity of the navigator cannot be guaranteed. The exclusion mechanisms based on the analysis of the residue are no longer pertinent.

In this same environment, a receiver using a simple vector tracking will be less sensitive to the disturbances introduced by the multipaths. The detection of contaminated channels is still carried out by comparing the measurement of the channel with the estimate produced by the navigator. This information is directly available at the output of the discriminators in a centralised architecture. As long as the navigator is healthy, the comparison tends to be null to the nearest noise. The advantage of this approach is that using a narrow discrimination window renders the measurement of the channel much less sensitive to multipaths, with the indirect signals falling more easily outside the discrimination window. The disadvantage of the approach is that the test concerning the output of the discriminator has low performance, due to the level of noise that affects this signal. An improvement in the test requires adapting the correlation time in order to reach the signal-to-noise ratio level desired, with this correlation time able to become prohibitive in case of unsteady phenomena. In addition, the test assumes that the state of the vehicle is perfectly described by the NCO of the vector loop, which is true only in the absence of acceleration of the vehicle. Moreover, using the output signal of the discriminator assumes that the disturbance can be measured by the discriminator the range of discrimination of which is of a limited width. Finally this approach is very sensitive to contamination of the navigator. Indeed, if contaminated channels succeed in degrading the estimate of the navigator, using narrow correlation windows easily leads to having a window that no longer contains the direct path. In this case, the measurement no longer converges. In addition, the vector measurement is more sensitive to the disturbances that the scalar measurement. Indeed, as the scalar measurement depends only on the measured channel it does not undergo the disturbances of the other channels and the power of the noise of the measurement depends on the quality of the signal and of the noise band of the estimator STL. On the contrary, the vector measurement, made from the estimate of the navigator aggregating all of the channels, is affected by disturbances within the other channels.

One of the innovating aspects of the invention resides in the possibility offered by the architecture of delivering at any time the measurements of delay obtained in the scalar and vector modes, making possible for each canal usage by the navigator of the measurement of the most pertinent delay. It moreover makes it possible to measure the differences between the estimates of scalar and vector delay, carried by the NCOs of the two loops. Contrary to the measurements made between the estimate of the navigator and the measurement of a tracking loop, scalar or vector, these measurements between the two types of loops allow for a more pertinent comparison. They represent the difference between the delay estimate obtained locally and the one obtained from the navigator, as for a received based on an architecture STL, but are elaborated from the same samples of the signal.

Indeed, the operating symmetry between the two types of loops, when they are placed in parallel, has for effect that there is no temporal bias between the two measurements. They are perfectly synchronous over time. This first point improves the pertinence of the measurement in comparison with the approach STL. Moreover, the measurements of the innovations made by comparing the delay estimated in scalar mode with the one obtained in vector mode benefits from the filtering carried out by these 2 estimators. The power of the noise on this signal is therefore lower than that of the noise that affects the discriminator of the loop VTL.

The architecture proposed therefore makes it possible, in comparison with prior art, to elaborate a measurement of the innovations (residues) on the delays using more pertinent measurements and affected with a lesser level of noise, facilitating the determination of the healthy channels and of the contaminated channels and the analysis of the integrity of the navigator. In addition, when these measurements detect a contaminated operation of the navigator, a reconfiguration of the receiver is still possible. A strong contamination of the navigator leasing to innovations that are incompatible with the width of the discrimination windows requires switching the receiver to the mode STL (mode 8.2 in FIG. 8). More likely, in the presence of visible satellites and when the tests carried out avoid a strong degradation of the navigator, the receiver can be placed in a degraded mode (mode 8.4 in FIG. 8) wherein the loops VTL operate on wider correlation windows is still possible. In this mode the control system benefits from the same measurements of the innovations, those that result from the comparison of the states of the NCOs of the loops STL and VTL. They are used to bring the navigator back to the operating integrity mode (mode 8.5 in FIG. 8).

FIG. 8 shows the various steps of the control according to an embodiment of the invention.

During a first step 8.1, the receiver does not have any information a priori on its position and its speed. It then carries out a step of acquiring satellites aiming to acquire a first estimation of its position. During this step, the lack of an estimate of the position and speed does not allow for the use of the tracking loops, which are either scalar or vector, which depend on a first estimate in order to work. At least four satellites must then be visible. This step is well known to those skilled in the art and details are not provided here.

Once these first estimates are acquired, the receiver then passes to a scalar operating mode 8.2. This is the operating mode of a conventional scalar receiver. Each satellite is tracked by a scalar tracking loop that elaborates local measurements. These local measurements are used by the navigator which then produces a healthy position if the measurements are healthy and tarnished with error otherwise. In this mode, the vector tracking loops are not used. This phase must make it possible to acquire more than 4 satellites.

When the navigator was able to converge towards an estimate of the position and speed, it then switches to a mode 8.3 referred to as the degraded mode VTL. In this mode, the receiver uses the wide discriminator of the loop VTL. It is not yet using the narrow discriminator. The measurements given by the wide loops VTL (4 or 5 satellites at the output of 8.2) are used by the navigator to construct its estimate. The integrity of the navigator then depends on the contamination of channels used. The vector and scalar tracking of the other satellites, deemed to be available according to their ephemerides, is carried out. The satellites the signal of which is masked require a scalar loop assisted by the vector loop, until a sufficient signal-to-noise ratio level is reached, greater than a given threshold in practice. The choice of the satellites is made according to the level of the signal-to-noise ratio.

The navigator then switches to a mode 8.4 referred to as transition mode. This here entail moving towards a healthy operation of the navigator. In this transition mode, the tracking of the signals is carried out in vector mode, and in parallel in scalar mode, based on wide discriminators. In practice, the detection of an erroneous measurement that affects the integrity of the solution concerns a statistical analysis of the residues. When the integrity criterion is not satisfactory, an exclusion of the contaminated satellites is necessary. Many approaches have been proposed to control the integrity of the navigator. The approaches use redundant measurements to check the consistency of the measurements produced. Those skilled in the art can adopt the approach that appears to be the most interesting by benefiting from residues which here advantageously come from the comparison of the estimates of the delay produced by the loops STL and VTL.

When an integrity fault is detected an exclusion procedure is carried out. It consists in selecting M healthy satellites. For information the number of combinations of M satellites among N is

$${C}_{N}^{M} = \frac{N !}{M ! ( N - M ) !} .$$

For N=6 and M=5, there are 6 combinations. For this step which consists in excluding the contaminated satellites those skilled in the art can adopt the solution which appears to be the most pertinent. Choosing the M satellites can consist, for example, in comparing the navigation solution obtained from N satellites available with that obtained from several sets of M satellites. The weighted least-squares algorithm is used here. The solution retained (that of the set of M satellites that gives the position that is closest to that obtained with the N satellites) is tested by using a statistical analysis of residues on the measurements of delay, obtained when the channels VTL are controlled by the navigator operating this solution. These residues here also advantageously come from the comparison of the estimates of delay produced by the loops STL and VTL.

It is proposed in this document to describe, for example, the so-called RCM (Range comparison approach) method the principle of which is as follows.

The channels that satisfy a signal-to-noise ratio level, are ranked in order of pertinence, according to the level of noise at the output of the phase discriminator and optionally to a measurement of the distortion of the autocorrelation function using the various correlators available. This phase makes it possible to retain only a limited number of satellites (N=6 for example).

Pertinent sets of 5 satellites are selected. For each set of 5 satellites, the following steps are carried out:
The position and the clock bias of the receiver are estimated by using the measurements delivered by the vector loop based on a wide discriminator. The least-squares algorithm is used.
The measurement of the delay of pertinent satellites discarded from the set is estimated from the solution (position, clock bias) obtained.
For each one of these satellites the measurement of the estimated delay is compared with the measurement delivered by the loop VTL.
The sets of satellites containing a contaminated satellite gives incoherent delay measurements. This makes it possible to decide the satellites to be discarded.
A set of 5 satellites delivering a measurement deemed to be healthy is used to control the NCOs of the vector loop.
An analysis of the residues obtained by comparing the states of the NCOs of the loops STL and VTL of the 5 channels selected is carried out.
The receiver is brought back to a healthy mode 8.5 when the quadratic sum of the residues remains less than a threshold which is fixed according to the quality of the signal.
In the healthy mode the navigator can use other channels, with the narrow discriminator making it possible to overcome the measurement errors due to distant multipaths.

It is possible to return to the healthy mode VTL 8.5 only if the navigator has integrity.

When the navigator is determined as healthy, it is then possible to switch to a mode 8.5 referred to as healthy VTL mode. In this mode, the narrow discriminator is used for the vector loops. The tracking of the channels by the scalar loops is also carried out, at least for the channels for which the signal-to-noise ratio is greater than a given threshold. The comparison of the scalar and vector estimates (states of the NCOs) is also continued in such a way as to be able to detect, during the step 8.5 the presence of multipaths, and measure during the step 8.6 the level of contamination of the navigator.

The approach is as follows. We begin with a test on the residues that makes it possible to detect the channels affected by multipaths. In practice, the presence of a multipath leads to an error on the vector loop operating in healthy mode if the amplitude of the multipath is such that it falls within the discrimination window. In this case, it is considered that the impact of this multipath does not significantly impact the receiver. However, it can be decided to discard this measurement if the GDOP (Geometry Dilution of Precision) obtained with the non-contaminated measurements is satisfactory. It can be retained otherwise. Indeed, it can be hoped that this measurement is outside of the narrow range of discrimination.

In parallel to this, a control of the integrity of the receiver is carried out. A measurement of the cumulative power of the signals, taken at the output of the prompt correlators of the loops VTL, and of the loops STL can be used. In case of contamination of the navigator, the prompt correlator of the loop VTL is no longer calibrated on the correlation peak of the signal. The level of power is then affected regardless of the channel, leading to a decrease in the cumulative power, compared to the cumulative power obtained at the output of the loop STL. This is particularly true when wide band BOC (Binary Offset of Carrier) signals, characterised by a narrow autocorrelation function, are addressed.

As soon as the loss of the healthy status of the navigator is detected, a measurement of the residues obtained by comparison of the states of the NCOs of the scalar and vector loops is carried out. The channels such that the residue is such that it allows for the use of the wide discriminator are used in transition mode 8.4. The channels that cannot function in mode VTL, because these loops are no longer operating within the range of discrimination, are placed in mode STL 8.2. The receiver will be able to return to the healthy mode VTL 8.5 only when the number of operating satellites is sufficient to return the receiver to a healthy mode.

During the possible loss of the healthy status of the navigator, the control loops on the state of transition 8.4 that aims to retrieve this state. The loss of integrity of the navigator can be due to a weakening in the satellite signals for example or to satellite masking, or to an exclusion fault of a contaminated measurement.

According to an advantageous embodiment, in the case of masking of a satellite, the dropout of the associated scalar loop is prevented by temporarily supplying the estimate of the navigator as input of the loop, i.e. as input of the replica signal generator. In this way, the loop STL can again track the satellite as soon as the masking is interrupted. This results in an improvement in availability.

A receiver based on the architecture proposed and benefiting from the control mode described therefore makes it possible to benefit from the robustness of the tracking in scalar mode with its wide delay-frequency discrimination window. The scalar discriminator, associated with the wide discriminator allows for an elaboration of residues that facilitates the detection of the contaminated measurements, and a contamination of the navigator. The mode 8.5 is the mode to be favoured. It benefits from narrow discriminators that make it possible to discard a maximum of indirect paths. The technique of elaborating residues, which makes it possible at any time to determine the integrity of the channels and of the navigator using pertinent, synchronous and low-noise measurements is advantageously used to maintain the navigator in the healthy mode 8.5. This mode facilitates the exclusion of contaminated measurements and, in case of loss of integrity of the navigator, makes it possible to return to a healthy state in a fast and robust manner.

FIG. 10 is a schematic block diagram of an information processing device 10.0 for the implementation of one or several embodiments of the invention. The information processing device 10.0 can be a peripheral device such as a micro-computer, a workstation or a mobile telecommunication terminal. The device 10.0 comprises a communication bus connected to:
a central processing unit 10.1, such as a microprocessor, noted as CPU;
a random access memory 10.2, noted as RAM, for memorising the code that can be executed of the embodiment of the invention as well as the registers adapted to save variables and parameters required for the implementing of the method according to embodiments of the invention, the memory capacity of the latter can be supplemented by an optional RAM memory connected to an extension port, for example;
a read-only memory 10.3, noted as ROM, for storing computer programs for implementing the embodiments of the invention;
a network interface 10.4 is normally connected to a communication network over which digital data to be processed is transmitted or received. The network interface 10.4 can be a single network interface or comprised of a set of different network interfaces (for example wired and wireless interfaces or different types of wired or wireless interfaces). Data packets are sent over the network interface for transmission or are read from the network interface for reception under the control of the software application executed in the processor 10.1;
a user interface 10.5 for receiving inputs from a user or for displaying information for a user;
an optional storage support 10.6 noted as HD;
an input/output module 10.7 for receiving/sending data from/to external devices such as a hard drive, removable storage support or others.

The executable code can be stored in a read-only memory 10.3, on the storage support 10.6 or on a digital removable support such as a disk. According to an alternative, the executable code of the program can be received by means of a communication network, via the network interface 10.4, in order to be stored in one of the means of storage of the communication device 10.0, such as the storage support 10.6, before being executed.

The central processing unit 10.1 is suitable for controlling and directing the execution of the instructions or portions of software code of the program or programs according to one of the embodiments of the invention, instructions which are stored in one of the aforementioned means of storage. After it is powered up, the CPU 10.1 is able to execute instructions stored in the main RAM memory 10.2, concerning a software application, after these instructions have been loaded from the ROM for example. Such a software, when it is executed by the processor 10.1, causes the steps of the flowcharts shown in FIG. 8 to be executed.

In this embodiment, the device is a programmable device that uses a piece of software to implement the invention. However, on a subsidiary basis, this invention can be implemented in the hardware (for example, in the form of a specific integrated circuit or ASIC).

Naturally, in order to satisfy the specific needs, a competent person in the field of the invention can make modifications in the preceding description.

Although this invention has been described hereinabove in reference to specific embodiments, this invention is not limited to the specific embodiments, and the modifications that fall within the scope of application of this invention will be obvious for those skilled in the art.

1. A satellite positioning device, comprising:
a module configured for radio receiving and digitising signals received from the satellites, each signal received from a satellite defining a satellite channel;
an estimator configured for determining a measurement of the delay and frequency of each satellite channel;
a navigator configured for determining from all of the measurements of the estimator an estimate of the position and speed of the device;
wherein the estimator comprises for each satellite channel:
a scalar tracking loop of the measurement of the delay;
a vector tracking loop of the measurement of the delay in parallel with the scalar loop; and
a comparator configured to compare the delay estimates of the scalar tracking loop and of the vector tracking loop produced by the estimators of said scalar and vector loops operating in parallel, for determining the integrity of the measurement of the delay and therefore of the satellite channel concerned.

2. The device according to claim 1, wherein said scalar and vector loops comprising numerically controlled oscillators carriers of the estimate of the delay of said loops, the comparator configured for comparing the state of said numerically controlled oscillators.

3. The device according to claim 1, wherein said scalar and vector loops comprising discriminators of the delay, the comparator configured for comparing the outputs of said discriminators.

4. The device according to claim 1, wherein the estimator further comprises:
means for determining the integrity of the navigator from the determination of the integrity of the measurements of the delay of all of the satellite channels.

5. The device according to claim 1, wherein the navigator comprises means for discarding the measurements from satellite channels determined as contaminated by the estimator.

6. The device according to claim 1, wherein:
the vector tracking loop comprises a first discriminator using correlators the offset of which is based on the power of the noise affecting the overall estimate of the navigator;
the vector tracking loop comprises a second discriminator using correlators the offset of which is based on the power of the noise affecting the local scalar estimate;
a controller configured for determining which discriminator is used to establish the measurement of the delay of the vector loop.

7. A method for controlling a satellite positioning device, comprising a module for radio receiving and digitising signals received from the satellites, each signal received from a satellite defining a satellite channel; an estimator for determining a measurement of the delay and frequency of each satellite channel and a navigator for determining from all of the measurements of the estimator an estimate of the position and speed of the device; the estimator comprising for each satellite channel: a scalar tracking loop of the measurement of the delay; a vector tracking loop of the measurement of the delay in parallel with the scalar loop; the method comprising:
comparing measurements of the delay of the scalar tracking loop and of the vector tracking loop produced by the estimators of said scalar and vector loops for determining the integrity of the measurement of the delay and therefore of the satellite channel concerned.

8. The method according to claim 7, wherein the vector tracking loop comprising a first discriminator using correlators the offset of which is based on the power of the noise affecting the local scalar estimate; the vector tracking loop further comprising a second discriminator using correlators the offset of which is based on the power of the noise affecting the overall estimate of the navigator; the method further comprises:
determining which discriminator is used to establish the measurement of the delay of the vector loop.

9. The method according to claim 8, comprising:
acquiring satellites;
switching to a scalar mode when a sufficient number of satellite is acquired, the measurement of the estimator then being produced by the scalar loop;
switching to a degraded vector mode when the navigator was able to converge towards an estimate of the position and speed, the measurement of the estimator then being produced by the vector loop based on the wide discriminator, the scalar loop being tracked in parallel;
switching to a transition mode, the measurement of the estimator then being produced by the vector loop based on the wide discriminator and on the narrow discriminator, the scalar loop being tracked in parallel;
switching to a healthy vector mode when the state of the navigator is determined to be healthy by comparison of the measurements of the scalar loop and of the vector loop, the measurement of the estimator then being produced by the vector loop based on the narrow discriminator, the scalar loop being tracked in parallel;
a second step of switching to the transition mode when the state of the navigator is determined to be contaminated by comparison of the measurements of the scalar loop and of the vector loop.

10. A computer program product comprising instructions suitable for the implementation of the method according to claim 7, when said program is executed on a computer.

11. A computer readable medium for storing information partially or entirely able to be read by a computer or a microprocessor, comprising instructions that when executed by the computer or the microprocessor carry out the method according to claim 7.
